(19) United States
(12) Patent Application Publication
(10) Pub. No.: US 2019/0206089 A1
(43) Pub. Date: Jul. 4, 2019

(54) BACKDROP COLOR DETECTION

(71) Applicant: Idemia Identity & Security USA LLC, Billerica, MA (US)

(72) Inventors: Yecheng Wu, Billerica, MA (US); Brian K. Martin, Billerica, MA (US)

(21) Appl. No.: 16/236,856

(22) Filed: Dec. 31, 2018

Related U.S. Application Data
(60) Provisional application No. 62/612,348, filed on Dec. 30, 2017.

(51) Int. Cl. G06T 7/90

(52) U.S. Cl. CPC G06T 7/90

(57) ABSTRACT

Methods, systems, and apparatus, including computer programs encoded on a computer storage medium, for determining a color space for analyzing a portrait image; identifying one or more sample areas of the portrait image; computing an average color value for pixels in each of the one or more sample areas; and detecting a backdrop color of the portrait by comparing the average color values for the one or more sample areas to predefined backdrop color values.

### FIELD

This specification relates to color detection in electronic/digital content.

### BACKGROUND

User identifications such as driver licenses can be issued either as physical identification cards or digital identifications. A physical identification card is issued by creating a card that includes customer or cardholder information, whereas a digital identification is issued in an electronic format and accessed using a client device. Both physical and digital identifications are commonly used for verifying the identity of an individual, providing access to restricted areas, or authorizing an individual to purchase age-restricted content.

Mobile computing devices such as smartphones and tablets can be used to capture digital images and video content of an identification card or document. The captured image or video content may be used to validate the authenticity of the card. Authenticity checks may require that relevant information on the identification be photographed with minimal glare, shadows, or other obscurities that can distort representations depicted in the captured image content.

### SUMMARY

This specification describes techniques for portrait image backdrop color detection. Systems and methods are described for detecting (e.g., automatically detecting) and identifying one or more colors included in a backdrop for a portrait image. Such detection can be used to optimize data processing of the image and device settings for generating a physical portrait that contains the image. For example, when processing a portrait image to be used for generating or printing an identification document, it can beneficial to know the backdrop color of the environment in which the portrait image is being captured. Accurate detection of the backdrop color enables a computing system to identify and use optimal processing algorithms and device print settings when generating an identification document that includes the image.

One aspect of the subject matter described in this specification can be embodied in a computer-implemented method. The method includes determining a color space for analyzing a portrait image; identifying one or more sample areas of the portrait image; computing a color value of pixels in each of the one or more sample areas; and detecting a backdrop color of the portrait image by comparing the computed color value of pixels in each of the one or more sample areas to a respective predefined backdrop color value.

These and other implementations can each optionally include one or more of the following features. For example, in some implementations, identifying the one or more sample areas of the portrait image includes identifying a first sample area in a backdrop region of the portrait image, wherein the first sample area has a fixed size that is based on M×N pixels. In some implementations, identifying the one or more sample areas of the portrait image includes identifying a second sample area in the backdrop region of the portrait image, wherein the second sample area has a fixed size that is based on a percentage of the length and width of the image.

In some implementations, computing the color value of pixels in each of the one or more sample areas includes computing an average value of each color component of all pixels in each of the one or more sample areas. In some implementations, the color space for analyzing the portrait image is an HSV color space including an H, S, and V color component and computing the color value of pixels in a sample area includes computing the average value of: a hue (H) color component of all pixels in the sample area; a saturation (S) color component of all pixels in the sample area; and a value (V) color component of all pixels in the sample area.

In some implementations, detecting the backdrop color of the portrait image includes comparing a respective average color value of each color component of all pixels in a sample area to each predefined backdrop color value in a listing that includes a plurality of predefined backdrop color values.

In some implementations, computing the color value of pixels in each of the one or more sample areas includes computing a median value of each color component of all pixels in each of the one or more sample areas. In some implementations, the color space for analyzing the portrait image is an HSV color space including an H, S, and V color component and computing the color value of pixels in a sample area includes computing the median value of: a hue (H) color component of all pixels in the sample area; a saturation (S) color component of all pixels in the sample area; and a value (V) color component of all pixels in the sample area.

Other implementations of this and other aspects include corresponding systems, apparatus, and computer programs, configured to perform the actions of the methods, encoded on computer storage devices (e.g., non-transitory machine-readable storage devices). A computing system of one or more computers or hardware circuits can be so configured by virtue of software, firmware, hardware, or a combination of them installed on the system that in operation cause the system to perform the actions. One or more computer programs can be so configured by virtue of having instructions that, when executed by data processing apparatus, cause the apparatus to perform the actions.

The subject matter described in this specification can be implemented to realize one or more of the following advantages. The described techniques can be used to enhance and optimize image processing based on automatic and accurate detection of one or more backdrop colors included in a portrait image. For example, a portrait image can be processed using at least backdrop color replacement or backdrop color removal prior to generating an identification document using the portrait. The described systems and methods enable accurate backdrop color detection in order to select and use the optimal processing algorithm and printer settings when processing a portrait image to be used for printing an identification document.

The details of one or more implementations of the subject matter described in this specification are set forth in the accompanying drawings and the description below. Other potential features, aspects, and advantages of the subject matter will become apparent from the description, the drawings, and the claims.

### BRIEF DESCRIPTION OF THE DRAWINGS

FIG. 1 shows a block diagram of a computing system for backdrop color detection.

FIG. 2 shows a flow diagram of an example process for backdrop color detection.

FIG. 3 shows a block diagram of a computing system that can be used in connection with computer-implemented methods described in this specification.

Like reference numbers and designations in the various drawings indicate like elements.

### DETAILED DESCRIPTION

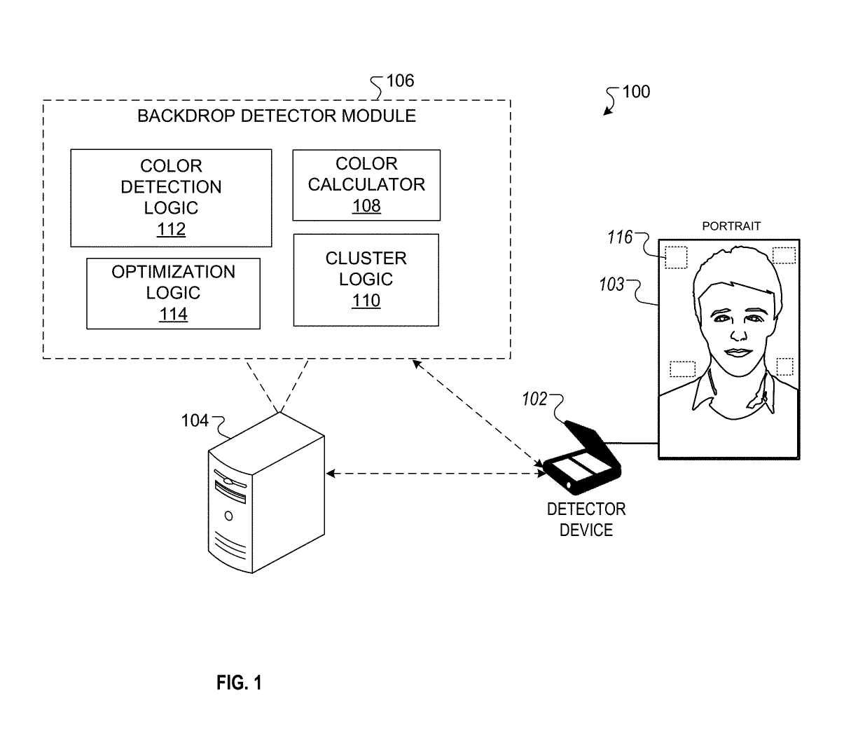

FIG. 1 shows a block diagram of a computing system 100 for backdrop color detection. System 100 generally includes detection device 102 and computing server 104. Device 102 can be a computing device that includes a camera application, an image data processor, or other related computing features for reading and analyzing image data for a portrait image 103. Device 102 is configured to exchange data communications with server 104 to process image pixel data for portrait 103.

In general, server 104 executes programmed instructions for detecting a backdrop color of portrait 103 based on analysis of image data for portrait 103. As descried in more detail below, server 104 includes a backdrop detector module 106 that includes multiple computing features. Each computing feature of module 106 corresponds to programmed code/software instructions for executing processes for backdrop color detection. While in typical implementations, computing features of server 104 are encoded on computer-readable media, in some implementations, these computing features are included within module 106 as a sub-system of hardware circuits that include one or more processing devices or processor microchips.

In general, module 106 can include processors, memory, and data storage devices that collectively form modules and computer systems of the module. Processors of the computer systems process instructions for execution by module 106, including instructions stored in the memory or on the data storage device to display graphical information for output at an example display monitor of system 100. Execution of the stored instructions can cause one or more of the actions described herein to be performed by module 106. In other implementations, multiple processors may be used, as appropriate, along with multiple memories and types of memory.

As used in this specification, and with reference to backdrop detector module 106, the term “module” is intended to include, but is not limited to, one or more computers configured to execute one or more software programs that include program code that causes a processing unit(s)/device(s) of the computer to execute one or more functions. The term “computer” is intended to include any data processing or computing devices/systems, such as a desktop computer, a laptop computer, a mainframe computer, a personal digital assistant, a server, a handheld device, a smartphone, a tablet computer, an electronic reader, or any other electronic device able to process data.

Module 106 generally includes color calculator 108, cluster logic 110, color detection logic 112, and optimization logic 114. In general, computing features of module 106 are used to automatically detect the backdrop color of a portrait image of portrait 103 and to select an optimal processing algorithm and printer settings for processing the image to generate an identification document. The described techniques can be implemented using one or more of the following processes.

For a color portrait image 103, module 106 is configured to set a color space to hue, saturation, and value (HSV), or any other color space (e.g., LAB, RGB, HSL, HSB, etc.). For example, each of HSL (hue, saturation, lightness) and HSV (hue, saturation, value) are alternative representations of the red, green, blue (RGB) color model. In some implementations, the color space can be a multi-dimensional color space.

For example, in the LAB (L*a*b) color model or color space, the color differences that can be perceived by an individual correspond to distances when measured colorimetrically in a multi-dimensional color space. In general, the LAB color model/space is based on one channel for Luminance (lightness) (L) and two color channels (a and b). In some cases, the lightness (L) may also correspond to a brightness value. This multi-dimensional space includes an a-axis that extends from green (−a) to red (+a) and a b-axis that extends from blue (−b) to yellow (+b). The brightness (L) increases from the bottom to the top of the three-dimensional model. In general, colors in portrait 103 can be represented within the color space by a specific color value for each dimension of the color space.

Module 106 is configured to define one or more sample areas 116 in the backdrop region of portrait 103. In some implementations, module 106 defines two small rectangular sample areas 116 in the upper left and upper right corner of portrait image 103. In some cases, module 106 can also define additional sample areas above the shoulders of an individual depicted in the portrait 103.

Sample areas 116 can be of a fixed size that is defined based on a number of pixels in the image. For example, a sample area 116 can have a size of 50×50 pixels or M×N pixels, where each of M and N are respective integer values that are greater than 1. A sample area 116 can have a size that is related to a size of the image, such as 10% of the image width and height or some percentage of a length of the image and a width of the image.

Module 106 uses the color calculator 108 to calculate an average or median value of each color component of all pixels within each sample area 116. For example, module 106 can define two sample areas and then use color calculator 108 to compute a respective average value for each of the hue (H) color component, the saturation (S) color component, and value (V) color component for all pixels in each of the two sample areas. Likewise, module 106 can define two sample areas and then use color calculator 108 to compute a respective median value for each of the hue (H) color component, the saturation (S) color component, and value (V) color component for all pixels in each of the two sample areas.

Cluster logic 110 is used to implement a clustering process. The clustering process is applied to detect or determine whether multiple colors exist in a backdrop of portrait 103. In some implementations, module 106 includes a list of know colors that are used for the backdrop. Module 106 compares the calculated sample area average color values (e.g., for all color components) to the list of multiple known colors used for the backdrop. For example, the list of multiple known or predefined colors that are used for backdrops can include white, gray, blue, green, or various other colors.

Module 106 determines a best matching color based on the comparison. For example, module 106 uses color detection logic 112 and color calculator 108 to compute a distance between a sampled color and each of the multiple known colors in the list of known colors. In some implementations, in addition to calculating the average values of color components, module 106 is also configured to compute other statistics and values associated with detecting colors of backdrop. For example, module 106 can compute variance values to determine uniformity attributes of the colors in the backdrop. In some implementations, module 106 also computes noise levels associated with colors in the backdrop.

Color detection logic 112 uses the computed distance values between the sampled color and the known colors to detect the back drop color. For example, logic 112 can analyze the computed distance values and can identify the backdrop color as the color that is closest in distance (in the color space) to a particular known color.

Based on the detected backdrop color, module 106 uses optimization logic 114 to select and use the optimal image processing algorithm and printer settings when processing a portrait image to print or generate an identification document. In some implementations, optimization logic 114 is used to enhance and optimize image processing based on automatic and accurate detection of one or more backdrop colors included in a portrait image. For example, the portrait image 103 can be processed using at least backdrop color replacement or backdrop color removal in response to detecting a particular backdrop color in the image 103.

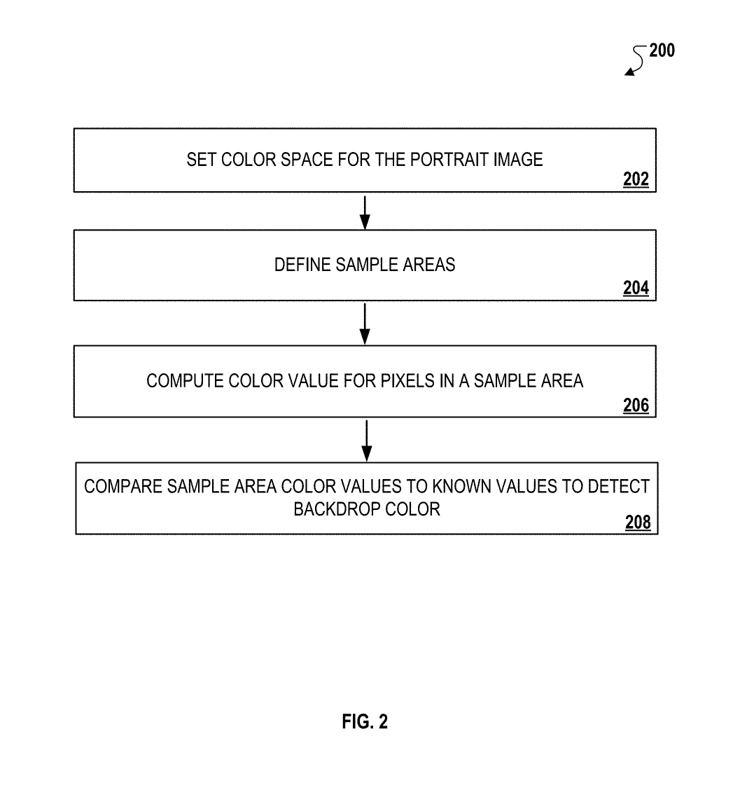

FIG. 2 shows a flow diagram of an example process 200 for backdrop color detection. Process 200 can be implemented or executed using the systems and devices described above. In some implementations, the described actions of process 200 are enabled by computing logic or programmed instructions executable by processing devices and memory of computing resources described in this document.

At block 202 of process 200, module 106 sets a color space for portrait 103. For example, module 106 can set the color space to hue, saturation, and value (HSV). Alternatively, module 106 can set the color space by selecting at least one color space from among multiple stored color spaces. For example, module 106 can select at least one of a LAB color space, an RGB color space, an HSL color space, or an HSB color space. As discussed above, each of HSL (hue, saturation, lightness) and HSV (hue, saturation, value) are alternative representations of the RGB color model. In some implementations, the color space can be a multi-dimensional color space. Colors in portrait 103 can be represented within the color space by a specific color value for each dimension of the color space.

At block 204, module 106 defines or identifies one or more sample areas associated with a backdrop of the portrait image 103. For example, module 106 can define one or more sample areas of the portrait image 103 by identifying a first sample area at a particular location in a backdrop region of the portrait image. The particular location can be an area that is above the shoulders of a person depicted in the image. In other cases, the particular location can be near or adjacent to a facial feature of the person depicted in the image. The first sample area can have a fixed size that is based on M×N pixels. Defining the one or more sample areas can also include identifying a second sample area in the backdrop region of the portrait image. The second sample area can have a size that is based on a percentage of the length and width of the image.

At block 206, system 100 computes color values for pixels in a sample area of the portrait image 103. For each sample area, system 100 can use the color calculator 108 of module 106 to compute an average color value of all pixels in the sample area, a median color value of all pixels in the sample area, or both. For example, computing the color value of pixels in each of the one or more sample areas can include computing an average or median color value of each color component of all pixels in each of the one or more sample areas.

In some cases, module 106 sets the color space for analyzing the portrait image to an HSV color space that includes a hue (H) color component, a saturation (S) color component, and a value (V) color component. In this case, computing the color value of pixels in a sample area includes computing the average (or median) color value of: the hue (H) color component of all pixels in the sample area; the saturation (S) color component of all pixels in the sample area; and the value (V) color component of all pixels in the sample area.

At block 208, module 106 compares sample area color values to known values to detect the backdrop colors. In some implementations, detecting the backdrop color of the portrait image 103 can include comparing a respective average color value of each color component of all pixels in a sample area to each predefined backdrop color value in a listing that includes multiple predefined backdrop color values. Likewise, detecting the backdrop color of the portrait image 103 can also include comparing a respective median color value of each color component of all pixels in a sample area to each predefined backdrop color value in a listing that includes multiple predefined backdrop color values.

In some implementations, module 106 is operable to automatically detect one or more backdrop colors included in a backdrop of a portrait image to optimize data processing of the image and device settings for generating a physical portrait that contains the image. For example, when system 100 processes a portrait image 103 to generate or print an identification document, module 106 is used to determine a backdrop color of the environment in which the portrait image is being captured. Module 106 executes logic 114 to identify and select optimal image processing algorithms and device print settings to generate an identification document that includes the image. In some cases, selection of the image processing algorithms is optimized relative to conventional methods for processing and generating portrait images for generating identification documents.

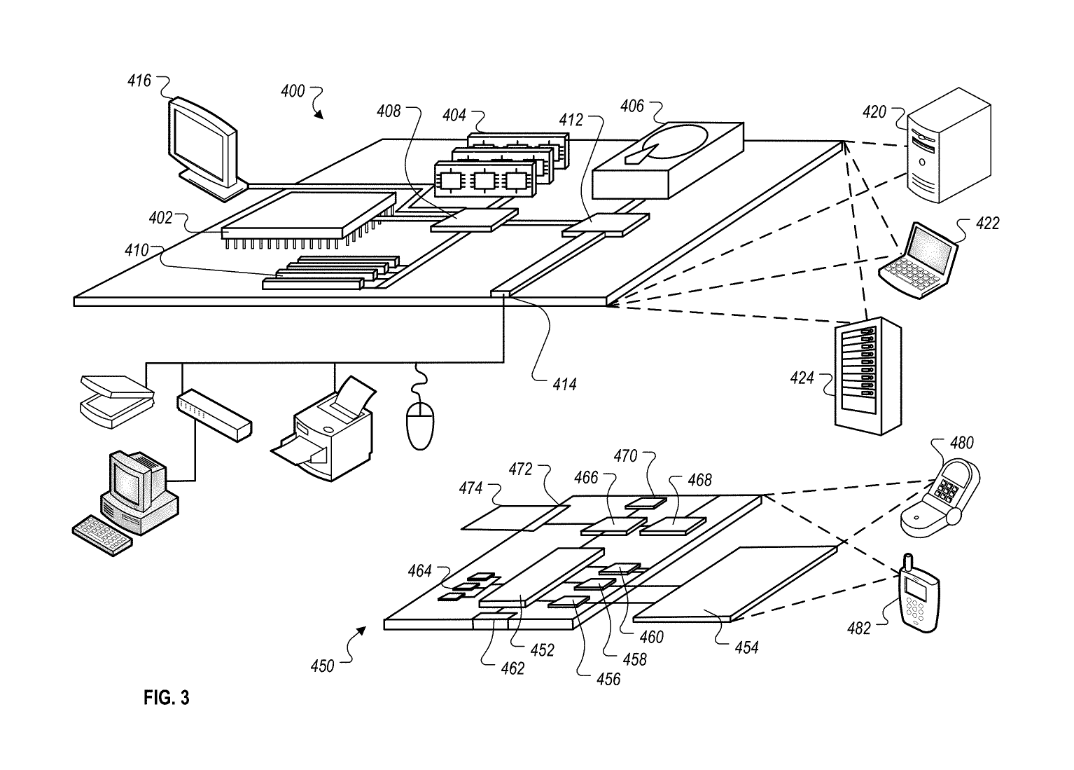

FIG. 3 is a block diagram of computing devices 400, 450 that may be used to implement the systems and methods described in this document, either as a client or as a server or plurality of servers. Computing device 400 is intended to represent various forms of digital computers, such as laptops, desktops, workstations, personal digital assistants, servers, blade servers, mainframes, and other appropriate computers. Computing device 450 is intended to represent various forms of mobile devices, such as personal digital assistants, cellular telephones, smartphones, smartwatches, head-worn devices, and other similar computing devices. The components shown here, their connections and relationships, and their functions, are meant to be exemplary only, and are not meant to limit implementations described and/or claimed in this document.

Computing device 400 includes a processor 402, memory 404, a storage device 406, a high-speed interface 408 connecting to memory 404 and high-speed expansion ports 410, and a low speed interface 412 connecting to low speed bus 414 and storage device 406. Each of the components 402, 404, 406, 408, 410, and 412, are interconnected using various busses, and may be mounted on a common motherboard or in other manners as appropriate. The processor 402 can process instructions for execution within the computing device 400, including instructions stored in the memory 404 or on the storage device 406 to display graphical information for a GUI on an external input/output device, such as display 416 coupled to high speed interface 408. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 404 stores information within the computing device 400. In one implementation, the memory 404 is a computer-readable medium. In one implementation, the memory 404 is a volatile memory unit or units. In another implementation, the memory 404 is a non-volatile memory unit or units.

The storage device 406 is capable of providing mass storage for the computing device 400. In one implementation, the storage device 406 is a computer-readable medium. In various different implementations, the storage device 406 may be a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 404, the storage device 406, or memory on processor 402.

The high-speed controller 408 manages bandwidth-intensive operations for the computing device 400, while the low speed controller 412 manages lower bandwidth-intensive operations. Such allocation of duties is exemplary only. In one implementation, the high-speed controller 408 is coupled to memory 404, display 416 (e.g., through a graphics processor or accelerator), and to high-speed expansion ports 410, which may accept various expansion cards (not shown). In the implementation, low-speed controller 412 is coupled to storage device 406 and low-speed expansion port 414. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 420, or multiple times in a group of such servers. It may also be implemented as part of a rack server system 424. In addition, it may be implemented in a personal computer such as a laptop computer 422. Alternatively, components from computing device 400 may be combined with other components in a mobile device (not shown), such as device 450. Each of such devices may contain one or more of computing device 400, 450, and an entire system may be made up of multiple computing devices 400, 450 communicating with each other.

Computing device 450 includes a processor 452, memory 464, an input/output device such as a display 454, a communication interface 466, and a transceiver 468, among other components. The device 450 may also be provided with a storage device, such as a microdrive or other device, to provide additional storage. Each of the components 450, 452, 464, 454, 466, and 468, are interconnected using various buses, and several of the components may be mounted on a common motherboard or in other manners as appropriate.

The processor 452 can process instructions for execution within the computing device 450, including instructions stored in the memory 464. The processor may also include separate analog and digital processors. The processor may provide, for example, for coordination of the other components of the device 450, such as control of user interfaces, applications run by device 450, and wireless communication by device 450.

Processor 452 may communicate with a user through control interface 458 and display interface 456 coupled to a display 454. The display 454 may be, for example, a TFT LCD display or an OLED display, or other appropriate display technology. The display interface 456 may comprise appropriate circuitry for driving the display 454 to present graphical and other information to a user. The control interface 458 may receive commands from a user and convert them for submission to the processor 452. In addition, an external interface 462 may be provided in communication with processor 452, so as to enable near area communication of device 450 with other devices. External interface 462 may provide, for example, for wired communication (e.g., via a docking procedure) or for wireless communication (e.g., via Bluetooth or other such technologies).

The memory 464 stores information within the computing device 450. In one implementation, the memory 464 is a computer-readable medium. In one implementation, the memory 464 is a volatile memory unit or units. In another implementation, the memory 464 is a non-volatile memory unit or units. Expansion memory 474 may also be provided and connected to device 450 through expansion interface 472, which may include, for example, a SIMM card interface. Such expansion memory 474 may provide extra storage space for device 450, or may also store applications or other information for device 450. Specifically, expansion memory 474 may include instructions to carry out or supplement the processes described above, and may include secure information also. Thus, for example, expansion memory 474 may be provided as a security module for device 450, and may be programmed with instructions that permit secure use of device 450. In addition, secure applications may be provided via the SIMM cards, along with additional information, such as placing identifying information on the SIMM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 464, expansion memory 474, or memory on processor 452.

Device 450 may communicate wirelessly through communication interface 466, which may include digital signal processing circuitry where necessary. Communication interface 466 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 468. In addition, short-range communication may occur, such as using a Bluetooth, WiFi, or other such transceiver (not shown). In addition, GPS receiver module 470 may provide additional wireless data to device 450, which may be used as appropriate by applications running on device 450.

Device 450 may also communicate audibly using audio codec 460, which may receive spoken information from a user and convert it to usable digital information. Audio codec 460 may likewise generate audible sound for a user, such as through a speaker, e.g., in a handset of device 450. Such sound may include sound from voice telephone calls, may include recorded sound (e.g., voice messages, music files, etc.) and may also include sound generated by applications operating on device 450. The computing device 450 may be implemented in a number of different forms, as shown in the figure. For example, it may be implemented as a cellular telephone 480. It may also be implemented as part of a smartphone 482, personal digital assistant, or other similar mobile device.

Various implementations of the systems and techniques described here can be realized in digital electronic circuitry, integrated circuitry, specially designed ASICs, computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs, also known as programs, software, software applications or code, include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device, e.g., magnetic discs, optical disks, memory, Programmable Logic Devices (PLDs) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

As discussed above, systems and techniques described herein can be implemented in a computing system that includes a back-end component, e.g., as a data server, or that includes a middleware component such as an application server, or that includes a front-end component such as a client computer having a graphical user interface or a Web browser through which a user can interact with an implementation of the systems and techniques described here, or any combination of such back-end, middleware, or front-end components. The components of the system can be interconnected by any form or medium of digital data communication such as, a communication network. Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

Further to the descriptions above, a user may be provided with controls allowing the user to make an election as to both if and when systems, programs or features described herein may enable collection of user information (e.g., information about a user's social network, social actions or activities, profession, a user's preferences, or a user's current location), and if the user is sent content or communications from a server. In addition, certain data may be treated in one or more ways before it is stored or used, so that personally identifiable information is removed. For example, in some embodiments, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

A number of embodiments have been described. Nevertheless, it will be understood that various modifications may be made without departing from the spirit and scope of the invention. For example, various forms of the flows shown above may be used, with steps re-ordered, added, or removed. Accordingly, other embodiments are within the scope of the following claims. While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment.

Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A computer-implemented method, comprising:
determining a color space for analyzing a portrait image;
identifying one or more sample areas of the portrait image;
computing a color value of pixels in each of the one or more sample areas; and
detecting a backdrop color of the portrait image by comparing the computed color value of pixels in each of the one or more sample areas to a respective predefined backdrop color value.

2. The method of claim 1, wherein identifying the one or more sample areas of the portrait image comprises:
identifying a first sample area in a backdrop region of the portrait image, wherein the first sample area has a fixed size that is based on M×N pixels.

3. The method of claim 2, wherein identifying the one or more sample areas of the portrait image comprises:
identifying a second sample area in the backdrop region of the portrait image, wherein the second sample area has a fixed size that is based on a percentage of the length and width of the image.

4. The method of claim 1, wherein computing the color value of pixels in each of the one or more sample areas comprises:
computing an average value of each color component of all pixels in each of the one or more sample areas.

5. The method of claim 4, wherein the color space for analyzing the portrait image is an HSV color space comprising an H, S, and V color component and computing the color value of pixels in a sample area comprises computing the average value of:
a hue (H) color component of all pixels in the sample area;
a saturation (S) color component of all pixels in the sample area; and
a value (V) color component of all pixels in the sample area.

6. The method of claim 5, wherein detecting the backdrop color of the portrait image comprises:
comparing a respective average color value of each color component of all pixels in a sample area to each predefined backdrop color value in a listing that includes a plurality of predefined backdrop color values.

7. The method of claim 1, wherein computing the color value of pixels in each of the one or more sample areas comprises:
computing a median value of each color component of all pixels in each of the one or more sample areas.

8. The method of claim 7, wherein the color space for analyzing the portrait image is an HSV color space comprising an H, S, and V color component and computing the color value of pixels in a sample area comprises computing the median value of:
a hue (H) color component of all pixels in the sample area;
a saturation (S) color component of all pixels in the sample area; and
a value (V) color component of all pixels in the sample area.

9. A system, comprising:
one or more processing devices; and
one or more non-transitory machine-readable storage devices storing instructions that are executable by the one or more processing devices to cause performance of operations comprising:
determining a color space for analyzing a portrait image;
identifying one or more sample areas of the portrait image;
computing a color value of pixels in each of the one or more sample areas; and
detecting a backdrop color of the portrait image by comparing the computed color value of pixels in each of the one or more sample areas to a respective predefined backdrop color value.

10. The system of claim 9, wherein identifying the one or more sample areas of the portrait image comprises:
identifying a first sample area in a backdrop region of the portrait image, wherein the first sample area has a fixed size that is based on M×N pixels.

11. The system of claim 10, wherein identifying the one or more sample areas of the portrait image comprises:
identifying a second sample area in the backdrop region of the portrait image, wherein the second sample area has a fixed size that is based on a percentage of the length and width of the image.

12. The system of claim 9, wherein computing the color value of pixels in each of the one or more sample areas comprises:
computing an average value of each color component of all pixels in each of the one or more sample areas.

13. The system of claim 12, wherein the color space for analyzing the portrait image is an HSV color space comprising an H, S, and V color component and computing the color value of pixels in a sample area comprises computing the average value of:
a hue (H) color component of all pixels in the sample area;
a saturation (S) color component of all pixels in the sample area; and
a value (V) color component of all pixels in the sample area.

14. The system of claim 13, wherein detecting the backdrop color of the portrait image comprises:
comparing a respective average color value of each color component of all pixels in a sample area to each predefined backdrop color value in a listing that includes a plurality of predefined backdrop color values.

15. The system of claim 9, wherein computing the color value of pixels in each of the one or more sample areas comprises:
computing a median value of each color component of all pixels in each of the one or more sample areas.

16. The system of claim 15, wherein the color space for analyzing the portrait image is an HSV color space comprising an H, S, and V color component and computing the color value of pixels in a sample area comprises computing the median value of:
a hue (H) color component of all pixels in the sample area;
a saturation (S) color component of all pixels in the sample area; and
a value (V) color component of all pixels in the sample area.

17. One or more non-transitory machine-readable storage devices for storing instructions that are executable by one or more processing devices to cause performance of operations comprising:
determining a color space for analyzing a portrait image;
identifying one or more sample areas of the portrait image;
computing a color value of pixels in each of the one or more sample areas; and
detecting a backdrop color of the portrait image by comparing the computed color value of pixels in each of the one or more sample areas to a respective predefined backdrop color value.

18. The one or more non-transitory machine-readable storage devices of claim 17, wherein identifying the one or more sample areas of the portrait image comprises:
identifying a first sample area in a backdrop region of the portrait image, wherein the first sample area has a fixed size that is based on M×N pixels.

19. The one or more non-transitory machine-readable storage devices of claim 18, wherein identifying the one or more sample areas of the portrait image comprises:
identifying a second sample area in the backdrop region of the portrait image, wherein the second sample area has a fixed size that is based on a percentage of the length and width of the image.

20. The one or more non-transitory machine-readable storage devices of claim 17, wherein computing the color value of pixels in each of the one or more sample areas comprises:
computing an average value of each color component of all pixels in each of the one or more sample areas.
